(19) United States
(12) Patent Application Publication
(10) Pub. No.: US 2005/0175008 A1
(43) Pub. Date: Aug. 11, 2005

(54) Method and system for replicating a video stream onto separate QAM downstream channels

(76) Inventor: Gordon Thompson, Alpharetta, GA (US)

Correspondence Address: ARRIS INTERNATIONAL, INC, 3871 LAKEFIELD DRIVE, SUWANEE, GA, 30024, US

(21) Appl. No.: 11/053,163

(22) Filed: Feb. 7, 2005

Related U.S. Application Data
(60) Provisional application No. 60/521,026, filed on Feb. 6, 2004.

(51) Int. Cl. H04L 12/56; H04L 12/28

(52) U.S. Cl. 370/390

(57) ABSTRACT

A system transports a single video stream from a video server over a WAN to a replicator at a specified IP address. The specified address may correspond to a RTP or UDP/IP address of an endpoint or port. A table at the replicator associates a plurality of downstream QAM channel frequencies with the specified address and the replicator creates as many copies of the stream as there are QAM channels associated with the IP address. The copies are forwarded to each of the QAM modulators that are tuned to one of the frequencies that are associated with the IP address. Grooming is done at each of the QAM modulators according to rules that correspond to the channel.

### CROSS REFERENCE TO RELATED APPLICATION

This application claims priority under 35 U.S.C. 119(e) to U.S. provisional patent application No. 60/521,026 entitled “Method and system for replicating video streams onto separate QAM downstream channels,” which was filed Feb. 6, 2004, and is incorporated herein by reference in its entirety.

### FIELD OF THE INVENTION

This invention relates, generally, to communication devices and, more particularly, to reducing bandwidth usage in transporting video streams from a receiving system to a network edge device.

### BACKGROUND

Cable television operators, often referred to as Multiple Services Operators (“MSO”), not only broadcast television network program content to all of their subscribers, but are also more and more providing video on demand services. Video on demand is typically provided from content stored on video servers or from satellite farms, both means known in the art. The content is typically forwarded from the servers or farms over a wide area network (“WAN”) to the MSO's head end facilities. When a subscriber requests particular content, a data stream is established from the server to the head end over the WAN, and QAM devices modulate the stream and send transmit it to the requesting subscriber.

Although this method is functional, WAN bandwidth is not efficiently used when more than one subscriber requests the same content. In this scenario, if two subscribers request the same content, two streams from the server to two corresponding QAM devices are transported over the WAN. Since each stream requires the same amount of WAN bandwidth, twice the bandwidth is used as is used if only one stream is transported. In the system 2 shown in FIG. 1, four streams 4 from servers 5 are transported over WAN 6 to QAM modulator devices 8. Each QAM sends a separate stream to a corresponding user device 10 at the users home or office.

Thus, to transport the four streams from servers 5 to QAM devices 8 uses four times as much bandwidth over WAN 6 as a single stream uses. Since the same content is being transported in each stream, there is a need in the art for a method and system for reducing the amount of bandwidth used to transport content from servers 5 over WAN 6 to QAM devices 8.

### SUMMARY

A video stream may be sent from a video server or satellite farm to a termination point at an edge QAM device. Such an endpoint may be a UDP/IP port or an RTP port. The stream is typically sent over a wide are network (“WAN”) that connects the servers and/or satellit4e antenna farm with the QAM modulator device(s) at the edge of the network that distributes content to subscribers. This network is typically a hybrid fiber coaxial (“HFC”) network, but other types of networks known in the art, may be used. When a stream is received at the termination point, the stream is replicated onto one or more downstream QAM channels. The QAM channel(s) over which the stream will be replicated and transported is/are associated with the termination point. Thus, when a server is directed to stream content to multiple users, an association between the intended users and the termination point is generated. When the server sends the stream to the users, it only sends a single stream to the QAM device, where the stream is then replicated onto channels that are associated with the intended users. Grooming operations, as known in the art, may be performed at the QAM device(s) per channel based on the subscribers, and their subscription terms and details.

### BRIEF DESCRIPTION OF DRAWINGS

FIG. 1 illustrates a convention system for providing multiple streams from a video server.

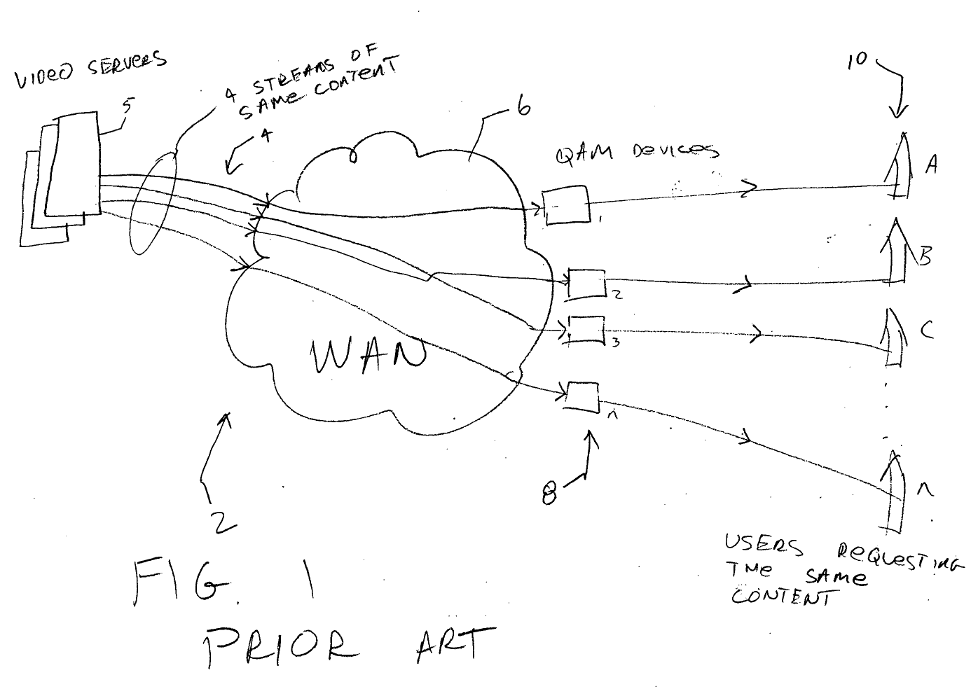

FIG. 2 illustrates a system for replicating a video stream from a server at a QAM device.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude any such other embodiments, adaptations, variations, modifications and equivalent arrangements, the present invention being limited only by the claims appended hereto and the equivalents thereof.

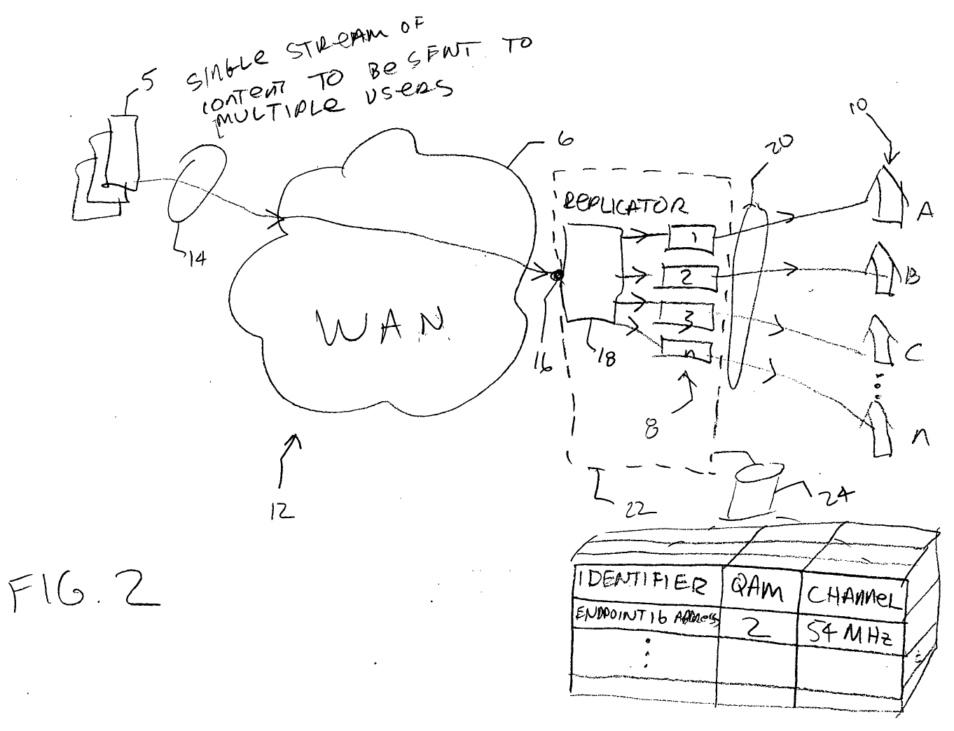

Turning back to the figures, FIG. 2 illustrates a system 12 for replicating a video stream 14 at the downstream side of WAN 6. Servers 5 transmit a stream across WAN 6 by opening a connection to an addressable termination point, such as for example, a UDP/IP port or preferably an RTP endpoint. It will be appreciated that UDP/IP and RTP are given as examples, and that other protocols may be used in addition to these examples given. Thus, an identifier, typically an IP address, of the destination endpoint is placed into packets transmitted from the video server, and the packet streams so encoded move across WAN 12 to the endpoint 16 at replicator 18.

Replicator 18 replicates the stream 14 received from WAN 6 into multiple copies of the stream, and outputs one of the copies to each of the QAM modulators 8. The QAM devices 8 transmit their corresponding streams to subscribers 10 over QAM channels 20. It will be appreciated that each QAM modulators 8 is shown having a single channel associated with it and being connected to a single user. However, those in the art will recognize that a single QAM channel 20 may deliver downstream content streams to multiple users 10, and that each QAM modulator device can transmit signals at different channels.

Replicator 18 and QAM modulators 8 typically compose a downstream transmitter distribution device 22 that may also include database tables and switching/routing devices to control where a signal stream is transmitted. Thus, the address of endpoint 16 would be associated with device 22 as a whole, rather than just with replicator 18.

As an example, a stream 14 is sent from server 5 across WAN 6 to the address of endpoint 16. When the stream is received at endpoint 16, the address of the endpoint is located in table 24 and the associated QAM modulator 8 and channel frequency of the QAM modulator is determined. The stream is then replicated as many times as there are QAM channels corresponding to the endpoint. It will be appreciated that table 24 may be represented as a three-dimensional table, where each indexed endpoint address may have associated with it more than one QAM modulator, and for each modulator corresponding to the endpoint address there may be associated therewith multiple channel frequencies.

Typically, a QAM modulator 8 produces one channel at a given frequency. In this case, there will be as many QAM modulators as there are QAM channels. Thus, a single stream from server 5 is transported across WAN 6, replicated at replicator 18 and provided to multiple QAM channel frequencies for delivery to subscribers 10. Device 22 may also groom the streams for each QAM channel 20 before being provided at the outputs of modulators 8, according to rules for each of the channels. Grooming is a term known in the art that refers to operations such as statistical multiplexing and implementing age restriction for certain content, etc., and need not be discussed further herein.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

1. A method for transporting a digitally encoded content stream from a content device over a wide area network through one or more distribution devices to a plurality of user devices, comprising:
associating an endpoint identifier with a termination point of the distribution device(s);
associating the termination point with a plurality of subscriber-channels for delivering the content stream to a plurality of user devices;
transmitting the stream to the termination point of the distribution device(s) associated with the endpoint identifier; and
replicating at the distribution device(s) the transmitted stream into a number of streams corresponding to the plurality of user devices.

2. The method of claim 1 wherein the endpoint identifier is a UDP/IP port address.

3. The method of claim 1 wherein the endpoint identifier is a RTP port address.

4. The method of claim 1 wherein the distribution device includes a QAM modulator.

5. The method of claim 4 wherein a QAM modulator outputs more than one downstream channel frequency.

6. The method of claim 1 wherein the endpoint identifier is associated with a plurality of downstream QAM channels, said QAM channels configured for providing the content streams to given subscribers.

7. A system for transporting a digitally encoded content stream from a content device over a wide area network through one or more distribution devices to a plurality of user devices, comprising:
means for associating an endpoint identifier with a termination point of the distribution device(s);
means for associating the termination point with a plurality of subscriber-channels for delivering the content stream to a plurality of user devices;
means for transmitting the stream to the termination point of the distribution device(s) associated with the endpoint identifier; and
means for replicating at the distribution device(s) the transmitted stream into a number of streams corresponding to the plurality of user devices.

8. The system of claim 7 wherein the endpoint identifier is a UDP/IP port address.

9. The system of claim 7 wherein the endpoint identifier is a RTP port address.

10. The system of claim 7 wherein the distribution device includes a QAM modulator.

11. The system of claim 10 wherein a QAM modulator outputs more than one downstream channel frequency.

12. The system of claim 7 wherein the endpoint identifier is associated with a plurality of downstream QAM channels, said QAM channels configured for providing the content streams to given subscribers.

13. The system of claim 7 wherein the means for associating an endpoint identifier with a termination point of the distribution device(s) includes a memory means for storing the identifier and a processor means for applying the identifier to packets of the content stream.

14. The system of claim 7 wherein the means for replicating at the distribution device(s) the transmitted stream into a number of streams corresponding to the plurality of user devices is a stream replicator.

15. The system of claim 7 wherein the means for transmitting the stream to the termination point of the distribution device(s) associated with the endpoint identifier is a server capable of transmitting content streams in data packets.
